(19) United States
(12) Patent Application Publication
(10) Pub. No.: US 2012/0099195 A1
(43) Pub. Date: Apr. 26, 2012

(54) EYEWEAR, THREE-DIMENSIONAL IMAGE DISPLAY SYSTEM EMPLOYING THE SAME, AND METHOD OF ALLOWING VIEWING OF IMAGE

(76) Inventors: Myung-ryul Choi, Seoul (KR); Nag-eui Choi, Suwon-si (KR)

(21) Appl. No.: 13/277,281

(22) Filed: Oct. 20, 2011

(30) Foreign Application Priority Data
Oct. 21, 2010 (KR) 10-2010-0103055

(51) Int. Cl. G02B 27/22

(52) U.S. Cl. 359/466

(57) ABSTRACT

A 3D image display system that includes eyewear and a 3D image display device for alternately displaying left and right images. The eyewear includes left and right shutters of the glasses which are controlled in a two-dimensional (2D) mode so as to allow only one of the left and right images displayed on the 3D image display device to be viewed, such that a user may view a 2D image when the 3D image display device displays a 3D image.

### CROSS-REFERENCE TO RELATED PATENT APPLICATION

This application claims the benefit of Korean Patent Application No. 10-2010-0103055, filed on Oct. 21, 2010, in the Korean Intellectual Property Office, the entire disclosure of which is incorporated herein by reference for all purposes.

### BACKGROUND

1. Field

The following description relates to a three-dimensional (3D) image display system, and additionally, to glasses used to view a 3D image, a 3D image display system employing the same, and a method of allowing viewing of an image.

2. Description of the Related Art

According to technological developments, an image display system capable of displaying an image more realistically is required. As such, in addition to having developed a high-resolution image display device having an increased number of pixels that is configured to display an image, a three-dimensional (3D) image display system that is configured to display an image three-dimensionally has been developed.

An image is displayed three-dimensionally due to stereoscopic vision of two eyes of a human. The two eyes of a human are separated from each other by a distance of about 65 mm. Binocular parallax occurs because of the distance separating the two eyes from each. Accordingly, the distance between the two eyes of a human and the associated binocular parallax is a main factor for generating a 3D effect. As such, if different view images corresponding to real images viewed by the two eyes are input to the two eyes, a 3D effect may be easily achieved. To produce such an effect, two identical left and right cameras are spaced apart from each other by the distance between the two eyes to capture left and right images, and the left image captured by the left camera and the right image captured by the right camera are respectively viewed by left and right eyes.

3D image display systems using binocular parallax include stereoscopic image display systems using glasses and autostereoscopic image display systems without using glasses. For example, the stereoscopic image display systems include a polarization glass system and a shutter glass system, and the autostereoscopic image display systems include a parallax barrier system, a lenticular system, an integral imaging system, and a holographic system. In comparison to autostereoscopic image display systems, stereoscopic image display systems have simple structures, provide a wide choice of viewing positions, and thus have been broadly commercialized.

### SUMMARY

In one general aspect there is provided eyewear through which left and right images alternately displayed on a three-dimensional (3D) image display device are viewed. The eyewear includes left and right shutters, a shutter driving unit that is configured to drive the left and right shutters, and a control unit that is configured to control the shutter driving unit in a two-dimensional (2D) mode in which only one of the left and right images displayed on the 3D image display device is viewable.

The eyewear may include a control unit that comprises a 3D/2D mode change unit that is configured to change the eyewear between 2D and 3D modes.

The eyewear may include a control unit that controls the shutter driving unit so as to simultaneously open and close the left and right shutters in synchronization with only one of the left and right images displayed on the 3D image display device, if the 3D/2D mode change unit changes the 3D mode into the 2D mode. The eyewear may include a control unit that controls the shutter driving unit so as to open and close the left shutter in synchronization with the left image being displayed on the 3D image display device, and to open and close the right shutter in synchronization with the right image being displayed on the 3D image display device, if the 3D/2D mode change unit changes the 2D mode into the 3D mode.

The eyewear may include a fatigue level detection unit that is configured to detect a fatigue level of a user who views a 3D image through the eyewear as the eyewear is in the 3D mode.

The eyewear may include a fatigue level detection unit such that the fatigue level detection unit includes a fatigue information sensing unit that is configured to sense user information, and a fatigue level determination unit that is configured to calculate a fatigue level of the user based on the user information, and to compare the calculated fatigue level to a reference value.

The eyewear may include a fatigue level display unit that is configured to display information associated with the fatigue level of the user.

The eyewear may include a mode change display unit that is configured to display a message prompts the user to decide whether to change the 3D mode into the 2D mode, if the fatigue level determination unit determines that the fatigue level is greater than the reference value.

The 3D/2D mode change unit may manually or automatically change the 3D mode into the 2D mode if the fatigue level determination unit determines that the fatigue level is greater than the reference value.

The eyewear may include an eye dominance selection unit that is configured to select a left eye dominance mode or a right eye dominance mode.

The eyewear may be configured such that in the 2D mode, the control unit controls the shutter driving unit to simultaneously open and close the left and right shutters in synchronization with only the left image displayed on the 3D image display device in the left eye dominance mode, and to simultaneously open and close the left and right shutters in synchronization with only the right image displayed on the 3D image display device in the right eye dominance mode.

The eyewear may include a dominant eye information sensing unit that is configured to sense user information, and an eye dominance determination unit for determining eye dominance of the user based on the user information.

The eye dominance determination unit may be configured to operate such that in a left-eye test mode for opening the left shutter and closing the right shutter in synchronization with only one of the left and right images displayed on the 3D image display device so as to determine whether the user has left eye dominance, and in a right-eye test mode for closing the left shutter and opening the right shutter in synchronization with only one of the right and right images displayed on the 3D image display device so as to determine whether the user has right eye dominance.

The eyewear may be configured such that the left eye dominance mode or the right eye dominance mode is manually or automatically selected according to the user's eye dominance determined by the eye dominance determination unit.

The eyewear may include a fatigue information sensing unit that is configured to sense user information, a fatigue level calculation unit that is configured to calculate a fatigue level of the user based on the user information, and a fatigue level determination unit that is configured to compare the fatigue level calculated by the fatigue level calculation unit, to a reference value. The fatigue information sensing unit may also be used as the dominant eye information sensing unit.

In another aspect, there is provided a three-dimensional (3D) image display system. The 3D image display system includes a 3D image display device for alternately displaying left and right images, and eyewear through which the left and right images displayed on the 3D image display device are viewed. The eyewear includes left and right shutters, a shutter driving unit that is configured to drive the left and right shutters, and a control unit that is configured to control the shutter driving unit in a two-dimensional (2D) mode in which only one of the left and right images displayed on the 3D image display device is viewable.

The eyewear may include at least one of a fatigue level detection unit that is configured to detect a fatigue level of a user who views a 3D image through the eyewear as the eyewear is in a 3D mode, and an eye dominance selection unit that is configured to select a left eye dominance mode or a right eye dominance mode.

The 3D image display device comprises at least one of a fatigue level detection unit that is configured to detect a fatigue level of a user who views a 3D image through the eyewear as the eyewear is in a 3D mode, and an eye dominance selection unit that is configured to select a left eye dominance mode or a right eye dominance mode.

In another aspect, there is provided a method of allowing viewing of left and right images alternately displayed on a three-dimensional (3D) image display device. The method includes preparing eyewear comprising left and right shutters, and controlling the left and right shutters in a two-dimensional (2D) mode in which only one of the left and right images displayed on the 3D image display device is viewable.

The controlling of the left and right shutters may include controlling the left and right shutters so as to be simultaneously open and closed in synchronization with only one of the left and right images displayed on the 3D image display device.

The method may include sensing user information of a user who wears the glasses, calculating a fatigue level of the user based on the sensed user information, and changing a 3D mode into the 2D mode if the calculated fatigue level is greater than a reference value.

Other features and aspects may be apparent from the following detailed description, the drawings, and the claims.

### BRIEF DESCRIPTION OF THE DRAWINGS

FIG. 1 is a drawing that illustrates an example of a three-dimensional (3D) image display system.

FIG. 2 is a diagram that illustrates an example of a 3D image display system.

FIG. 3 is a drawing that illustrates an example of a 3D mode operation of glasses of a 3D image display system.

FIG. 4 is a drawing that illustrates an example of a two-dimensional (2D) mode operation of the glasses of a 3D image display system.

FIG. 5 is a drawing that illustrates an example of glasses employed in a 3D image display system.

FIG. 6 is a diagram that illustrates an example of glasses employed in a 3D image display system.

FIG. 7 is a diagram that illustrates an example of a 3D image display system employing glasses.

FIG. 8 is a flowchart that illustrates an example of a method of changing between 2D and 3D modes in a 3D image display system.

FIG. 9 is a drawing that illustrates an example of glasses employed in a 3D image display system.

FIG. 10 is a diagram that illustrates an example of a 3D image display system employing glasses.

FIG. 11 is a flowchart that illustrates an example of a method of selecting eye dominance in a 3D image display system.

FIG. 12 is a diagram that illustrates an example of glasses employed in a 3D image display system.

FIG. 13 is a diagram that illustrates an example of a 3D image display system employing glasses.

FIG. 14 is a flowchart that illustrates an example of a method of determining eye dominance in a 3D image display system.

FIG. 15 illustrates glasses employed in a 3D image display system.

FIG. 16 is a diagram that illustrates an example of a 3D image display system employing glasses.

FIG. 17 is a flowchart that illustrates an example of a method of changing between 2D and 3D modes in a 3D image display system.

FIG. 18 is a diagram that illustrates an example of a 3D image display system.

FIG. 19 is a diagram that illustrates an example of the 3D image display system.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

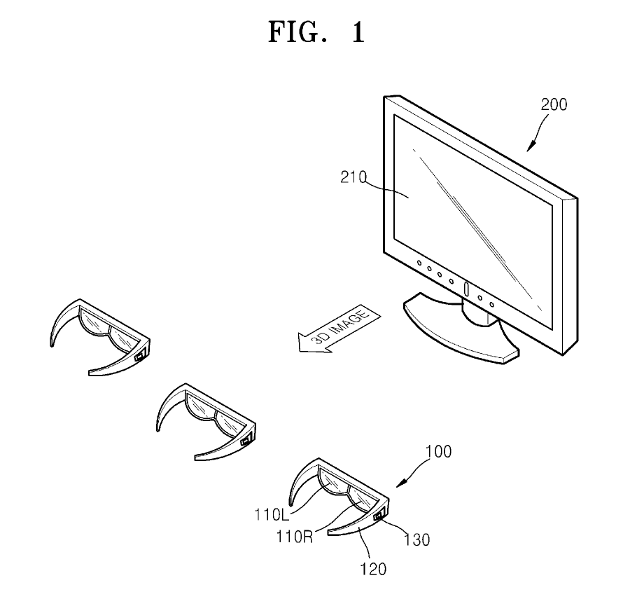

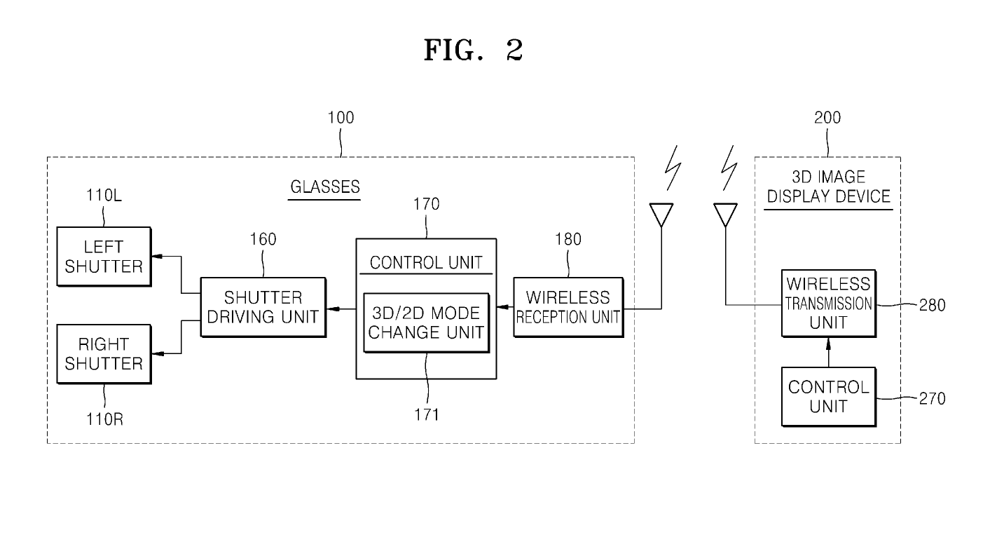

FIG. 1 illustrates an example of a three-dimensional (3D) image display system. FIG. 2 is a block diagram of a 3D image display system.

Referring to FIGS. 1 and 2, the 3D image display system includes glasses 100 and a 3D image display device 200.

As an example, the glasses 100 allow viewing of an image displayed on the 3D image display device 200, and include left and right shutters 110L and 110R that respectively correspond to left and right lenses of glasses frames 120. A change switch 130 may be formed on the glasses frames 120. For example, the change switch 130 may be formed at one side of the glasses frames 120. The glasses may include a driving circuit. For example, the driving circuit unit of the glasses 100 includes a shutter driving unit 160, a control unit 170, and a wireless reception unit 180.

The left and right shutters 110L and 110R respectively correspond to left and right lenses of the glasses 100 and transmit or block light. For example, the left and right shutters 110L and 110R may selectively transmit and/or block light. The left and right shutters 110L and 110R may be shutters configured to mechanically or optically transmit or block light. For example, the left and right shutters 110L and 110R may be liquid crystal shutters that are configured to transmit or block light of a predetermined polarization (e.g., P polarization).

The shutter driving unit 160 is a circuit that is configured to drive the left and/or right shutters 110L and 110R. The shutter driving unit 160 operatively opens or closes the left and right shutters 110L and 110R. For example, the shutter driving unit 160 may open and/or close the left and right shutters 110L and 110R by applying a current and/or a voltage. The shutter driving unit 160 may differ according to a driving method of the left and right shutters 110L and 110R, and may be a well-known circuit element.

The control unit 170 controls the shutter driving unit 160, and may include a 3D/2D mode change unit 171 that is configured to change the glasses 100 between two-dimensional (2D) and three-dimensional (3D) modes.

For example, the 3D/2D mode change unit 171 may change between 2D and 3D modes based on a user's selection. In other words, a user may selectively change the 3D/2D mode of the glasses 100 so as to change between the 2D and 3D modes. As an example, a user may toggle between 2D and 3D modes by using the change switch 130.

The wireless reception unit 180 receives a synchronization signal from the 3D image display device 200, and transmits the synchronization signal to the control unit 170. The control unit 170 controls the shutter driving unit 160. For example, the control unit 170 may control the shutter driving unit 160 in synchronization with the synchronization signal transmitted from the reception unit 180.

The 3D image display device 200 includes an image panel 210 for displaying a 3D image, a control unit 270, and a wireless transmission unit 280.

The image panel 210 is an image display device. For example, the image panel 210 may be a display device such as a liquid crystal panel, an organic light emitting diode (OLED) panel, a plasma display panel (PDP), a cathode ray tube (CRT), a projection display device, or the like. For example, if the left and right shutters 110L and 110R of the glasses 100 are liquid crystal shutters for transmitting or blocking light of a predetermined polarization, the image panel 210 may be a liquid crystal panel for emitting only light of the predetermined polarization.

The control unit 270 controls the 3D image display device 200. As an example, the control unit 270 may transmit to the wireless transmission unit 280 a synchronization signal corresponding to the display of the left and right images. As another example, the image panel 210 may transmit to the wireless transmission unit 280 a synchronization signal used to display left and right images.

As an example, the wireless transmission unit 280 may transmit to the reception unit 180 the synchronization signal received from the control unit 270 of the 3D image display device 200. As another example, the wireless transmission unit 280 may broadcast the synchronization signal. In other words, the wireless transmission unit 280 may transmit the synchronization signal received from the control unit 270 of the 3D image display device 200 to at least one device none of which was a predefined device. In such an example, the wireless reception unit 180 on each of the plurality of devices may detect and/or receive the transmitted synchronization signal.

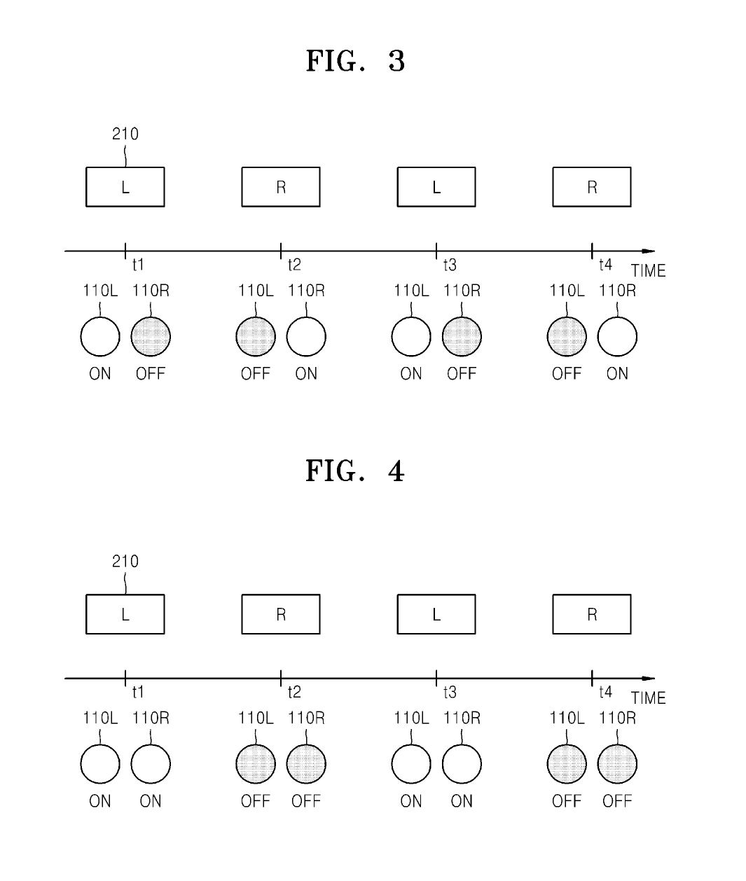

Operation of a 3D image display system will now be described with reference to FIGS. 3 and 4.

FIG. 3 illustrates an example of a 3D mode operation of the glasses 100 of a 3D image display system. For example, FIG. 3 illustrates an example of a 3D mode operation of the glasses 100 of the 3D image display system illustrated in FIG. 1.

Referring to FIG. 3, the image panel 210 of the 3D image display device 200 alternately displays left and right images L and R. The left and right images L and R have a binocular parallax (e.g., 6.5 cm) at a predetermined viewing position. If the left and right images L and R are respectively viewed by left and right eyes of a user at the predetermined viewing position, the user may experience a 3D effect due to the binocular parallax.

The left shutter 110L of the glasses 100 is driven to be open when the left image L is displayed, and to be closed when the right image R is displayed. For example, the left shutter 110L of the glasses 100 may be driven to be open only when the left image L is displayed. The right shutter 110R of the glasses 100 is driven to be open when the right image R is displayed, and to be closed when the left image L is displayed. For example, the right shutter 110R of the glasses 100 may be driven to be open only when the right image R is displayed. The left and right shutters 110L and 110R may be driven as described above in a cycle by using a synchronization signal used to alternately display the left and right images L and R on the 3D image display device 200.

For example, at time points t1, t3, and so on, the image panel 210 displays the left image L, the left shutter 110L is open, the right shutter 110R is closed, and thus a user wearing the glasses 100 views only the left image L. Also, at time points t2, t4, and so on, the image panel 210 displays the right image R, the right shutter 110R is open, the left shutter 110L is closed, and thus the user wearing the glasses 100 views only the right image R. As a result, the user wearing the glasses 100 alternately views the left and right images L and R having a binocular parallax. Accordingly, the user wearing the glasses 100 views a 3D image.

FIG. 4 illustrates an example of a 2D mode operation of the glasses 100 of a 3D image display system. For example, FIG. 4 illustrates an example of a 2D mode operation of the glasses 100 of the 3D image display system illustrated in FIG. 1.

Referring to FIG. 4, as in the above-described 3D mode operation, the image panel 210 of the 3D image display device 200 alternately displays left and right images L and R. That is, the 3D image display device 200 displays a 3D image.

In a 2D mode, the glasses 100 are driven to allow viewing of only one of the left and right images L and R of the 3D image display device 200. For example, the left and right shutters 110L and 110R of the glasses 100 are driven to be open only when the left image L is displayed, and to be closed when the right image R is displayed. As another example, the left and right shutters 110L and 110R of the glasses 100 may be driven to be open only when the right image R is displayed, and to be closed when the left image L is displayed. As an example, determination as to whether to synchronize the left and right shutters 110L and 110R with the left image L or the right image R may be determined according to a dominant eye of the user, as will be described later with reference to FIG. 10.

The left and right shutters 110L and 110R may be driven as described above in a cycle by using a synchronization signal used to alternately display the left and right images L and R on the 3D image display device 200.

For example, at time points t1, t3, and so on, the image panel 210 displays the left image L, the left and right shutters 110L and 110R are simultaneously open, and thus a user wearing the glasses 100 views the left image L with both eyes. As an example, the user wearing the glasses may only view the left image L with both eyes. Also, at time points t2, t4, and so on, the image panel 210 displays the right image R, the left and right shutters 110L and 110R are simultaneously closed, and thus the user wearing the glasses 100 does not view the right image R with both eyes. As a result, even when the image panel 210 alternately displays the left and right images L and R, the user wearing the glasses 100 views the left image L and not the right image R. Thus, the user wearing the glasses 100 recognizes an image displayed on the image panel 210 as a 2D image.

As described above, the 3D image display system supports a 2D mode for allowing a user wearing the glasses 100 to view a 2D image even if the 3D image display device 200 displays a 3D image. In general, a user may have dizziness caused by, for example, fatigue, while viewing a 3D image. An image displayed on a conventional 3D image display device may be changed from a 3D image into a 2D image (assuming that the conventional 3D image display device supports a 2D image). For example, if there is a single user or if all users collectively agree, the image displayed on a conventional 3D image display device may be changed from a 3D image into a 2D image. If a plurality of users view a 3D image displayed on the conventional 3D image display device together, a user having dizziness (or otherwise desires to not view the 3D image) has to either suppress the dizziness or stop viewing the 3D image. On the other hand, in a case of the 3D image display system in which a user may selectively toggle between 2D and 3D mode (e.g., using a control unit on the glasses worn by the user), even when a plurality of users view a 3D image displayed on the 3D image display device 200 together, a user having dizziness may change the user's glasses 100 from a 3D mode into a 2D mode, may view the 3D image displayed on the 3D image display device 200 as a 2D image without changing the state of the 3D image display device 200, and thus may get rid of the dizziness caused by the 3D image. Accordingly, the selection between a 2D mode and a 3D mode is personal to a user and may be toggled without otherwise affecting how other users view the image.

Alternate displaying of the left and right images L and R on the image panel 210 does not always mean that the left and right images L and R are alternately displayed on the image panel 210 in units of a whole screen. For example, the image panel 210 may display the left and right images L and R in units of sequential and alternate lines, and the left and right shutters 110L and 110R of the glasses 100 may be open or closed in units of corresponding lines. In this case, the glasses 100 are driven in units of corresponding lines to allow alternate viewing of the left and right images L and R of the 3D image display device 200 in a 3D mode, and to allow viewing of only one of the left and right images L and R of the 3D image display device 200 in a 2D mode.

As example, the 3D/2D mode change unit 171 and the change switch 130 respectively in the glasses may be omitted. As such, the glasses 100 may be 2D-mode exclusive glasses that are configured to be driven only in a 2D mode. Accordingly, although some examples of the glasses 100 are glasses which are capable of changing between 2D and 3D modes to allow selective viewing of a 2D image or a 3D image, glasses may be provided which are exclusively driven for viewing images in 2D mode.

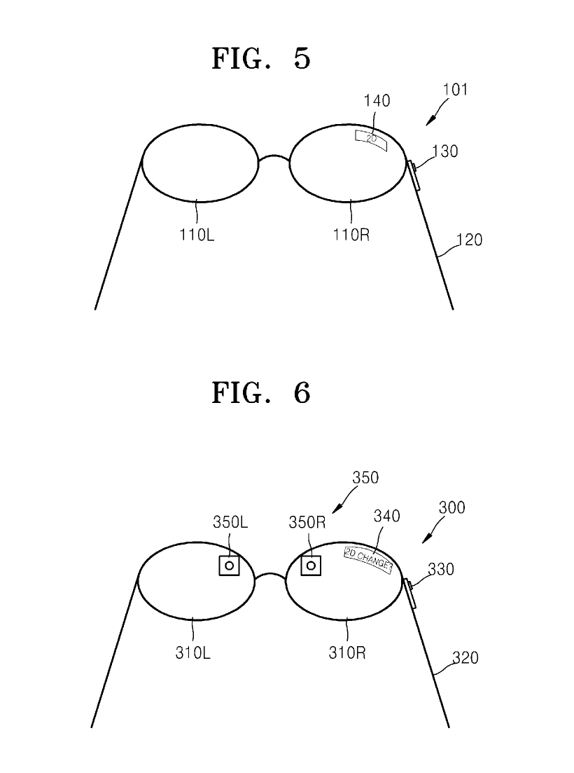

FIG. 5 illustrates an example of a modified example of glasses 101 employed in a 3D image display system.

Referring to FIG. 5, the glasses 101 further include a mode display unit 140 that is configured to display whether a current mode is a 3D mode or a 2D mode. The mode display unit 140 may be formed at a location where a user is able to see the mode display unit 140 while wearing. The mode display unit 140 may also be formed at a location where a user is able to see the mode display unit 140 while both wearing or not wearing the glasses 101. For example, the mode display unit 140 may be formed on an outer side of the left shutter 110L or the right shutter 110R, or a lens rim of the glasses frames 120. The mode display unit 140 may be a liquid crystal display (LCD) device, a light-emitting diode (LED) display device, an OLED display device, or a lamp, and may display text or symbols. The mode display unit 140 communicates to a user whether the glasses 101 are in 2D mode or 3D mode.

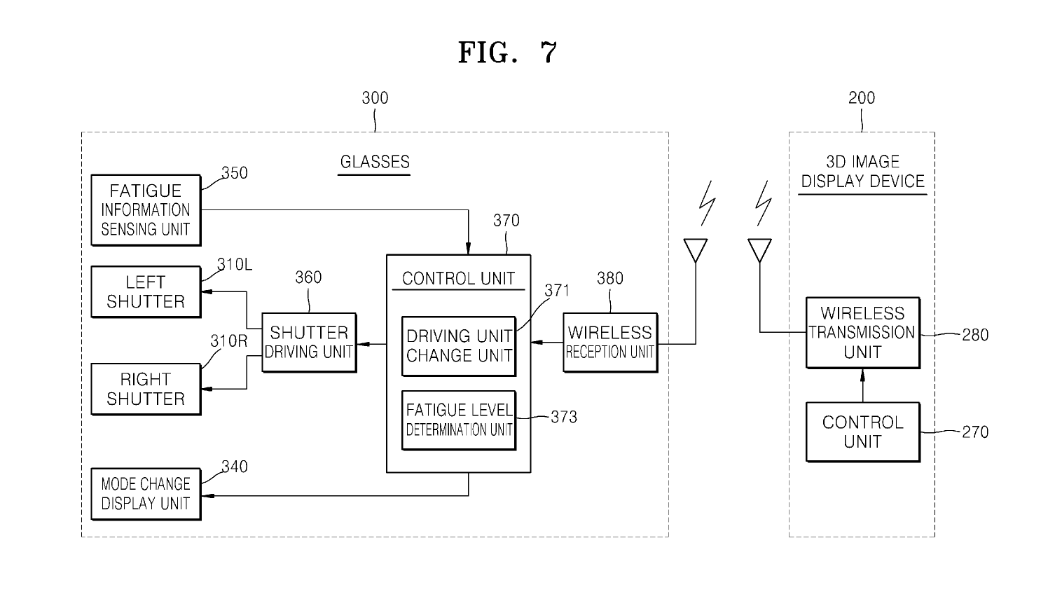

FIG. 6 illustrates an example of glasses 300 employed in a 3D image display system. FIG. 7 is a diagram illustrating an example of a 3D image display system employing the glasses 300, such as glasses 300 illustrated in FIG. 6, for example.

Referring to FIGS. 6 and 7, the 3D image display system includes the glasses 300 and a 3D image display device 200. An example of a 3D image display device 200 is described above in relation to FIGS. 1 through 4.

The glasses 300 allow viewing of an image displayed on the 3D image display device 200, and include left and right shutters 310L and 310R. The left and right shutters 310L and 310R may respectively correspond to left and right lenses of glasses frames 320. A change switch 330 may be formed at one side of the glasses frames 320. Also, the glasses 300 may further include a mode change display unit 340 formed at a location where a user is able to see the mode change display unit 340 while wearing and/or not wearing the glasses 300. For example, the mode change display unit 340 may be formed on an outer side of the left shutter 310L or the right shutter 310R, or a lens rim of the glasses frames 320. In addition, the glasses 300 further include a fatigue information sensing unit 350 that is configured to sense biological information regarding fatigue of the user. A driving circuit unit of the glasses 300 includes a shutter driving unit 360, a control unit 370, and a wireless reception unit 380. The control unit 370 includes a 3D/2D mode change unit 371 that is configured to change between 2D and 3D modes, and a fatigue level determination unit 373 that is configured to determine a fatigue level of the user. The fatigue information sensing unit 350 and the fatigue level determination unit 373 are an example of a fatigue information sensing unit that are configured to detect the fatigue level of the user. The fatigue information sensing unit 350 may be a photodetector or a body temperature sensor that is configured to sense the biological information. For example, if the fatigue information sensing unit 350 is a photodetector, as illustrated in FIG. 6, the fatigue information sensing unit 350 may include left and right sensors 350L and 350R respectively. The left and right sensors 350L and 350R may be formed at outer sides of the left and right shutters 310L and 310R. The left and right sensors 350L and 350R may respectively sense blinks of left and right eyes of the user. Because blinking frequencies of the left and right eyes are closely correlated with the fatigue of the user, the blinking frequencies of the left and right eyes of the user is an example of the biological information regarding the fatigue of the user. As another example, the glasses 300 may have only one of the left and right sensors 350L and 350R formed thereon. In other words, one of the left and right sensors 350L and 350R or both such sensors may be used to detect a user's fatigue.

The fatigue information sensing unit 350 of the glasses 300 may further sense, for example, biological information regarding excitement of the user. Biological information associated with excitement of the user may be detected if the user is excessively immersed in viewing a 3D image. As an example, the glasses 300 may include an excitement sensing unit (not shown) for sensing the biological information regarding the excitement of the user. For example, the fatigue information sensing unit 350 may be a body temperature sensor. The body temperature sensor may be formed on the glasses frames 320 adjacent to, for example, a nose, a temple, or an ear of the user to sense a variation in body temperature of the user. Because a rapid variation in body temperature is closely correlated with the excitement of the user, the variation in body temperature of the user is an example of the biological information regarding the excitement of the user.

The biological information sensed by the fatigue information sensing unit 350 is input to the fatigue level determination unit 373 of the control unit 370. The fatigue level determination unit 373 may calculate the fatigue level of the user based on the input biological information. The fatigue level determination unit 373 may compare the fatigue level with a reference value. For example, the fatigue level determination unit 373 may determine whether the calculated fatigue level is greater than a reference value. As an example, the fatigue level may be calculated by using data such as correlations between eye blinks and fatigue. As an example, if the calculated fatigue level is greater than the reference value, the mode change display unit 340 may display a message asking whether to change modes. Also, the fatigue level calculated by the fatigue level determination unit 373 may be displayed on the mode change display unit 340 or an additional fatigue level display unit (not shown). The mode change display unit 340 may be formed integrally with or separately from the mode display unit 140 illustrated in FIG. 5.

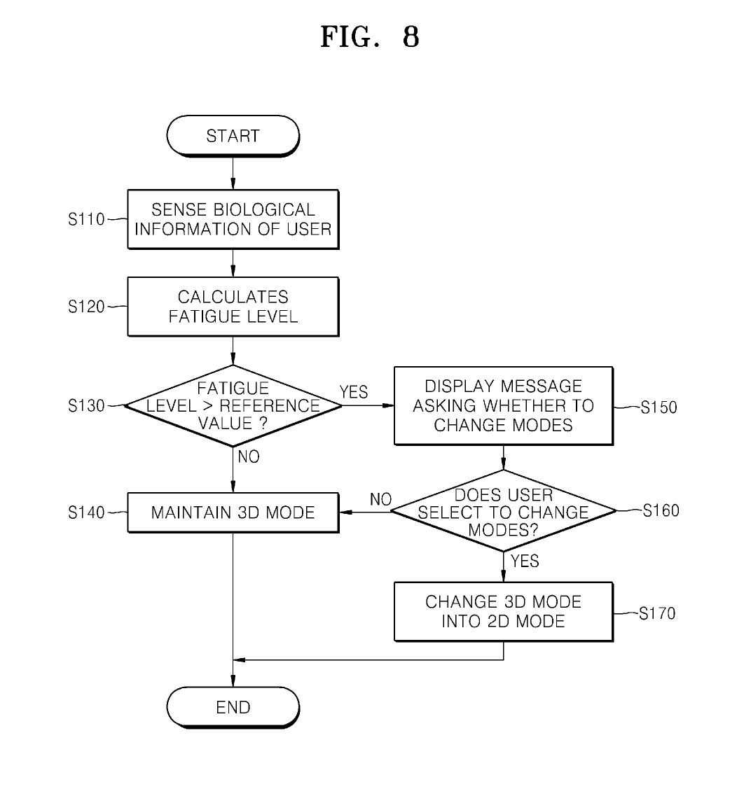

Operation of a 3D image display system such as, for example, the system described with reference to FIGS. 6 and 7 will now be described with reference to FIG. 8. 2D and 3D mode operations of the glasses 300 and a 3D image display operation of the 3D image display device 200 may be the same as those described above in relation to FIGS. 1 through 5. In addition to the 2D and 3D mode operations and the 3D image display operation, the 3D image display system may change modes by sensing fatigue of a user. An example of a 3D image display system changing modes based on a sensed fatigue of a user is described below.

FIG. 8 is a flowchart illustrating an example of a method of changing between 2D and 3D modes in the 3D image display system.

Referring to FIG. 8, it is assumed that a user views a 3D image displayed on the 3D image display device 200 in a 3D mode of the glasses 300. The glasses 300 sense biological information of the user in a predetermined cycle by using the fatigue information sensing unit 350 (operation S110). As an example, operation S110 may be performed by manual manipulation by the user.

The fatigue level determination unit 373 calculates a fatigue level by using the sensed biological information (operation S120), and determines, for example, whether the calculated fatigue level is greater than a reference value (operation S130). If the fatigue level is equal to or less than the reference value, the 3D mode of the glasses 300 is maintained (operation S140). Otherwise, if the fatigue level is greater than the reference value, a message asking whether to change the 3D mode into a 2D mode is displayed on, for example, the mode change display unit 340 (operation S150). If the user does not react for a predetermined period of time or selects by using the change switch 330 not to change modes (operation S160), the 3D mode of the glasses 300 is maintained (operation S140). Otherwise, if the user selects by using the change switch 330 to change the 3D mode into the 2D mode (operation S160), the 3D/2D mode change unit 371 of the glasses 300 changes the 3D mode into the 2D mode (operation S170).

As an example, the glasses 300 may be automatically changed from the 3D mode into the 2D mode if the fatigue level is greater than the reference value. In other words, the glasses 300 are not limited to requiring a user's selection to change from the 3D mode to the 2D mode.

As described above, in comparison to the glasses 100 and 101 illustrated in FIGS. 1 through 5, the glasses 300 may be manually or automatically changed from a 3D mode into a 2D mode in consideration of the fatigue level of a user by using the fatigue information sensing unit 350 and the fatigue level determination unit 373.

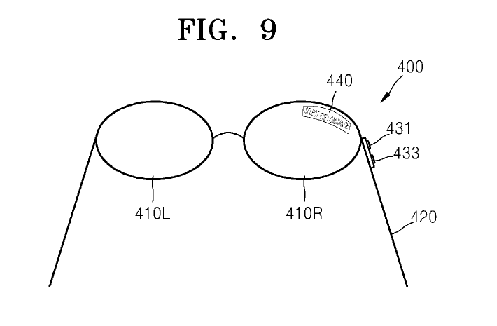

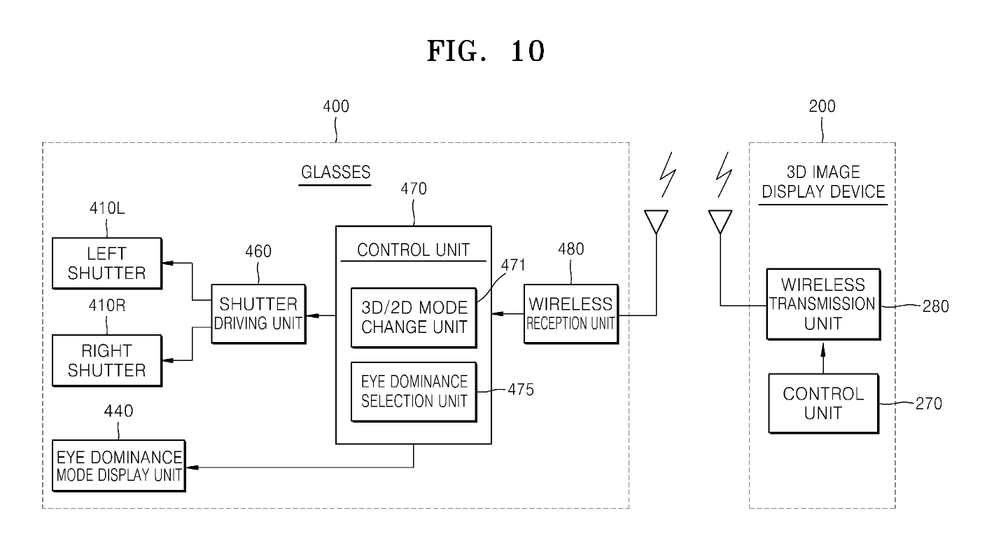

FIG. 9 illustrates an example of glasses 400 employed in a 3D image display system. FIG. 10 is a block diagram that illustrates an example of a 3D image display system. For example, FIG. 10 illustrates an example of a 3D image display system that may employ the glasses 400 illustrated in FIG. 9.

Referring to FIGS. 9 and 10, the 3D image display system includes the glasses 400 and a 3D image display device 200. The 3D image display device 200 is described above in relation to FIGS. 1 through 4.

The glasses 400 allow a user to view an image displayed on the 3D image display device 200. For example, the glasses 400 include left and right shutters 410L and 410R which respectively correspond to left and right lenses of glasses frames 420. As an example, the glasses 400 may include a change switch 431 and/or a selection switch 433. For example, change switch 431 and/or the selection switch 433 may be formed at one side of the glasses frames 420. As another example, a change switch 431 and a selection switch may be formed on different sides of the glasses frame 420. The glasses 400 may further include an eye dominance mode display unit 440. The eye dominance mode display unit 440 may be formed at a location where a user is able to see the eye dominance mode display unit 440 while wearing or not wearing the glasses 400. For example, the eye dominance mode display unit 440 may be formed on an outer side of the left shutter 410L or the right shutter 410R, or a lens rim of the glasses frames 420. A driving circuit unit of the glasses 400 includes a shutter driving unit 460, a control unit 470, and a wireless reception unit 480. The control unit 470 includes a 3D/2D mode change unit 471 for changing between 2D and 3D modes, and an eye dominance selection unit 475 configured to control a driving order of the left and right shutters 410L and 410R according to eye dominance of the user.

The selection switch 433 allows the user to select left eye dominance mode or right eye dominance mode directly or by displaying a message on the eye dominance mode display unit 440. For example, the selection switch 433 may be a switch that toggles between left eye dominance mode and right eye dominance mode when activated by the user. The eye dominance mode display unit 440 may display that the glasses 400 are currently in an eye dominance selection mode so as to allow the user to select the eye dominance of the user. The eye dominance mode display unit 440 may be formed integrally with or separately from the mode display unit 140 illustrated in FIG. 5 and/or the mode change display unit 340 illustrated in FIG. 6. The eye dominance selection unit 475 may operate in the eye dominance selection mode.

The other elements of the glasses 400 are similar to those elements illustrated in and described above in relation to FIGS. 1 through 4.

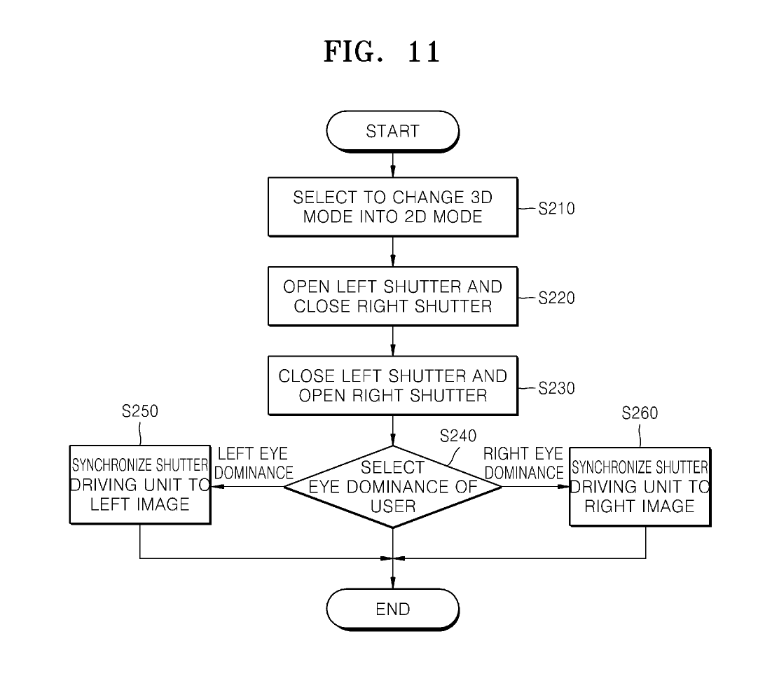

Operation of the 3D image display system will now be described with reference to FIG. 11. 2D and 3D mode operations of the glasses 400 and a 3D image display operation of the 3D image display device 200 are the same as those described above in relation to FIGS. 1 through 5. In addition to the 2D and 3D mode operations and the 3D image display operation, the 3D image display system selects eye dominance of a user as described below.

FIG. 11 is a flowchart illustrating an example of a method of selecting eye dominance in the 3D image display system. For example, FIG. 11 illustrates a method of selecting eye dominance in the 3D image display system illustrated in FIG. 10.

Referring to FIG. 11, if a user selects to change the glasses 400 from a 3D mode into a 2D mode (operation S210), an eye dominance selection mode is started. When the eye dominance selection mode is started, the eye dominance mode display unit 440 may display that the glasses 400 are in the eye dominance selection mode. The eye dominance selection mode includes an eye dominance test mode. The eye dominance test mode includes a left-eye test mode for opening the left shutter 410L and closing the right shutter 410R (operation S220), and a right-eye test mode for closing the left shutter 410L and opening the right shutter 410R (operation S230). The left-eye test mode (operation S220) and the right-eye test mode (operation S230) may be switched with each other, and may be repeated. The eye dominance mode display unit 440 may display in operation S220 that the glasses 400 are in the left-eye mode, and may display in operation S230 that the glasses 400 are in the right-eye mode. After that the eye dominance test mode, an eye dominance of the user is selected (operation S240). As an example, operation S240 may be performed between operations S220 and S230. If the user determines a left eye as a dominant eye and selects left eye dominance mode, the eye dominance selection unit 475 synchronizes the shutter driving unit 460 to a left image (operation S250). That is, the left and right shutters 410L and 410R of the glasses 400 are driven to be open only when the left image L (see FIG. 4) is displayed, and to be closed when the right image R (see FIG. 4) is displayed. If the user determines a right eye as a dominant eye and selects right eye dominance mode, the eye dominance selection unit 475 synchronizes the shutter driving unit 460 to a right image (operation S260). That is, the left and right shutters 410L and 410R of the glasses 400 are driven to be open only when the right image R is displayed, and to be closed when the left image L is displayed.

As described above, if eye dominance of a user is selected, the user may view an image more stably in a 2D mode of the glasses 400.

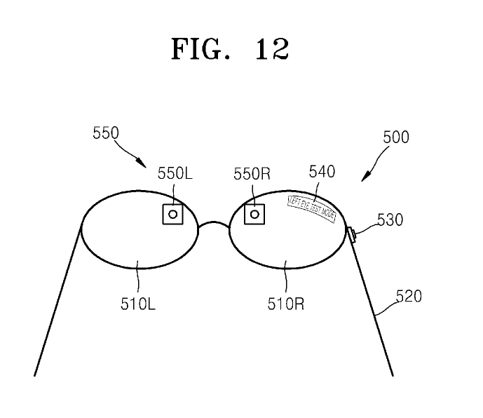

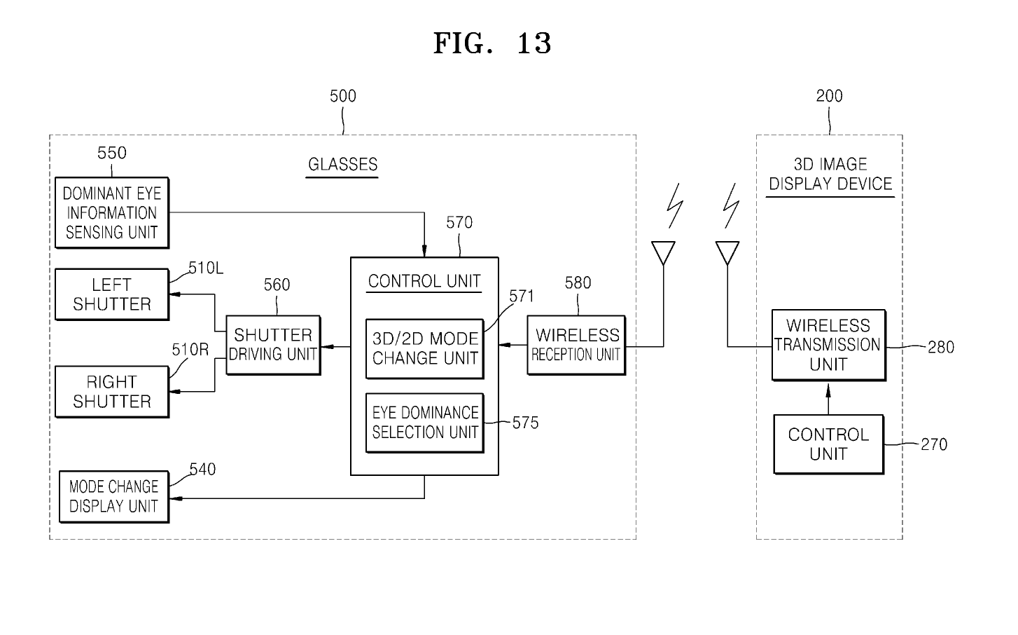

FIG. 12 illustrates an example of glasses 500 employed in a 3D image display system. FIG. 13 is a block diagram illustrating an example of a 3D image display system employing, for example, the glasses 500 illustrated in FIG. 12.

Referring to FIGS. 12 and 13, the 3D image display system includes the glasses 500 and a 3D image display device 200. The 3D image display device 200 is described above in relation to FIGS. 1 through 4.

The glasses 500 allow viewing of an image displayed on the 3D image display device 200, and include left and right shutters 510L and 510R. As an example, the left and right shutters 510L and 510R may respectively correspond to left and right lenses of glasses frames 520. The glasses 500 include a change switch 530. The change switch 530 may be formed, for example, at one side of the glasses frames 520. Also, the glasses 500 further include an eye dominance mode display unit 540. The eye dominance mode display unit 540 may be formed at a location where a user is able to see the eye dominance mode display unit 540 while wearing or not wearing the glasses 500. For example, the eye dominance mode display unit may be formed on an outer side of the left shutter 510L or the right shutter 510R, or a lens rim of the glasses frames 520. In addition, the glasses 500 may further include a dominant eye information sensing unit 550 that is configured to sense biological information regarding a dominant eye of the user. Meanwhile, a driving circuit unit of the glasses 500 includes a shutter driving unit 560, a control unit 570, and a wireless reception unit 580.

The dominant eye information sensing unit 550 may be a photodetector that is configured to sense the biological information. For example, as illustrated in FIG. 12, the dominant eye information sensing unit 550 may include left and/or right sensors 550L and/or 550R. The left and/or right sensors 550L and/or 550R may be respectively formed at outer sides of the left and right shutters 510L and 510R. For example, the left and right sensors 550L and 550R may respectively sense blinks of left and right eyes of the user. Because blinking frequencies of the left and right eyes are closely correlated with fatigue of the user and a non-dominant eye probably feels fatigue sooner than the dominant eye, the biological information regarding the dominant eye of the user may be sensed by using the blinking frequencies of the left and right eyes of the user. For example, the dominant eye information sensing unit 550 may sense if a left and/or right eye of the user blinks. Based on the sensed blinking of the left and/or right eye of the user, the dominant eye information sensing unit 550 or an eye dominance selection unit 575 may determine the frequencies of the left and right eye blinks. The dominant eye information sensing unit 550 or the eye dominance selection unit 575 may determine a user's dominant eye by comparing the frequencies of blinking for the respective left and right eyes. As an example, the frequency of the left and right eye blinks may be determined as an absolute frequency or a relative frequency.

The control unit 570 includes a 3D/2D mode change unit 571 for changing between 2D and 3D modes, and an eye dominance determination unit 575 that is configured to determine an eye dominance of the user. For example, the biological information sensed by the dominant eye information sensing unit 550 may be input to the eye dominance determination unit 575 of the control unit 570, and the eye dominance determination unit 575 calculates fatigue levels of the left and right eyes of the user based on the input biological information, and determines the eye dominance of the user. The eye dominance mode display unit 540 may display that the glasses 500 are in an eye dominance determination mode. As an example, the eye dominance mode display unit 540 may be formed integrally with or separately from a mode display unit such as the mode display unit 140 illustrated in FIG. 5 and/or the mode change display unit 340 illustrated in FIG. 6. The other features illustrated in FIGS. 12 and 13 substantially correspond to those of the glasses 100 illustrated in FIGS. 1 through 4. Therefore, for the clarity and conciseness, such features are not further described with regard FIGS. 12 and 13.

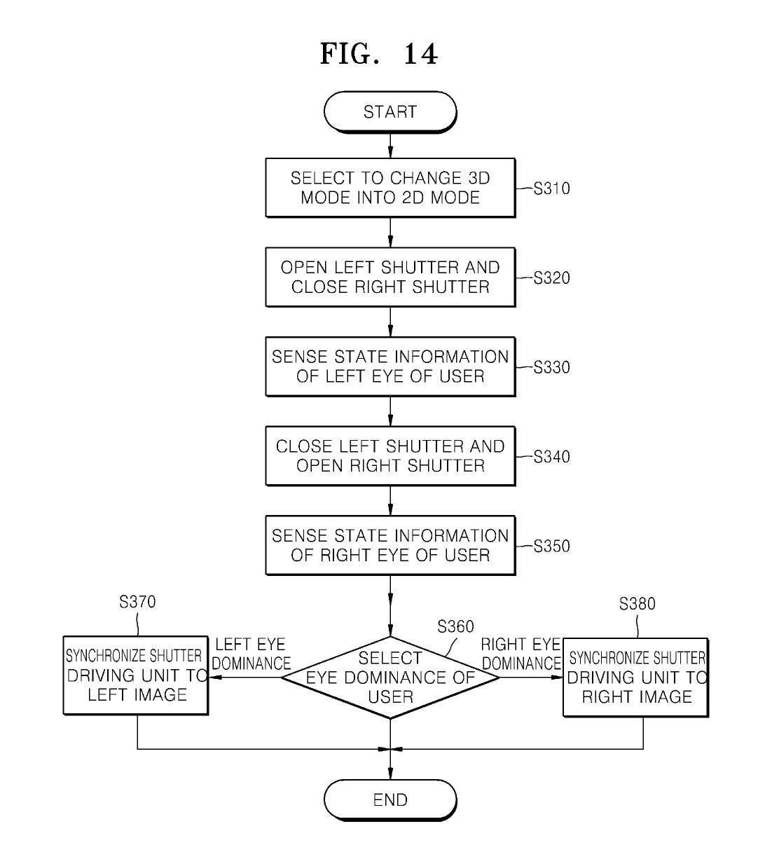

An example of operation of the 3D image display system will now be described with reference to FIG. 14. For example, 2D and 3D mode operations of the glasses 500 and a 3D image display operation of the 3D image display device 200 may be the same as those described above in relation to FIGS. 1 through 5. In addition to examples of the 2D and 3D mode operations and the 3D image display operation, an example of the 3D image display system selects eye dominance of a user as described below.

FIG. 14 is a flowchart of a method of determining eye dominance in a 3D image display system such as, for example, the 3D image display system illustrated in FIG. 13.

Referring to FIG. 14, if a user selects to change the glasses 500 from a 3D mode into a 2D mode (operation S310), an eye dominance determination mode is started. If the eye dominance determination mode is started, the eye dominance mode display unit 540 may display that the glasses 500 are in the eye dominance determination mode. For example, the eye dominance determination mode may include a left-eye mode for opening the left shutter 510L and closing the right shutter 510R (operation S320) and then sensing state information of a left eye of the user (operation S330), and a right-eye mode for closing the left shutter 510L and opening the right shutter 510R (operation S340) and then sensing state information of a right eye of the user (operation S350). The left-eye mode (operations S320 and S330) and the right-eye mode (operations S340 and S350) may be switched with each other, and may be repeated. The eye dominance mode display unit 540 may display in operations S320 and S330 that the glasses 500 are in the left-eye mode, and may display in operations S340 and S350 that the glasses 500 are in right-eye mode. After that, the eye dominance determination unit 575 compares the state information of the left and right eyes to determine eye dominance. For example, fatigue of the left and right eyes is sensed in the left-eye mode (operations S320 and S330) and the right-eye mode (operations S340 and S350). As an example, an eye that feels less fatigue is determined as a dominant eye (operation S360). If left eye dominance is determined, the control unit 570 synchronizes the shutter driving unit 560 to a left image (operation S370). In other words, the left and right shutters 510L and 510R of the glasses 500 are driven to be open when the left image L (see FIG. 4) is displayed, and to be closed when the right image R (see FIG. 4) is displayed. As an example, the left and right shutters 510L and 510R of the glasses 500 may be driven to be open only when the left image L is displayed. If right eye dominance is determined, the control unit 570 synchronizes the shutter driving unit 560 to a right image (operation S380). In other words, the left and right shutters 510L and 510R of the glasses 500 are driven to be open when the right image R is displayed, and to be closed when the left image L is displayed. As an example, the left and right shutters 510L and 510R may be drive to be open only when the left image R is displayed.

As described above, if eye dominance of a user is determined, the user may view an image more stably in a 2D mode of the glasses 500.

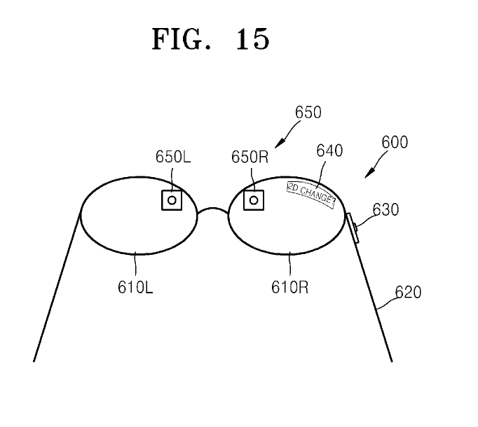

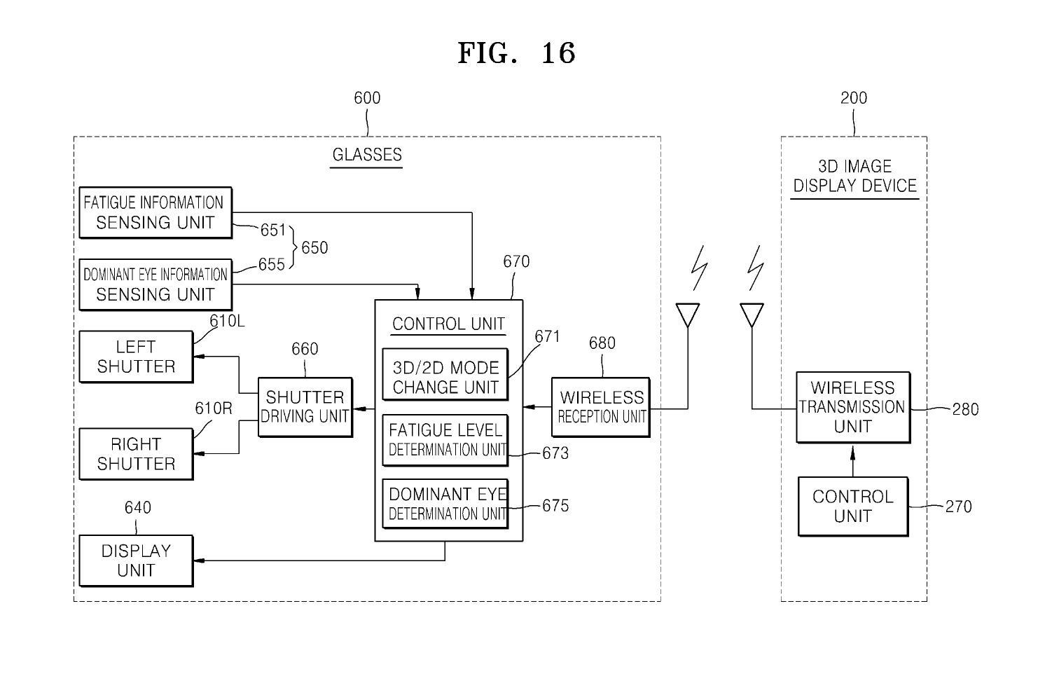

FIG. 15 illustrates an example of glasses 600 employed in a 3D image display system. FIG. 16 is a block diagram illustrating an example of a 3D image display system such as, for example, a 3D image display system employing the glasses 600 illustrated in FIG. 15.

Referring to FIGS. 15 and 16, the 3D image display system includes the glasses 600 and a 3D image display device 200. For example, the 3D image display device 200 is described above in relation to FIGS. 1 through 4.

The glasses 600 allow viewing of an image displayed on the 3D image display device 200, and include left and right shutters 610L and 610R. For example, the left and right shutters 610L and 610R may respectively correspond to left and right lenses of glasses frames 620. A change switch 630 is provided to enable a user to change between the 2D and 3D modes. As an example, the change switch 630 may be formed at one side of the glasses frames 620. The glasses 600 may further include a display unit 640. The display unit may be formed at a location where a user is able to see the display unit 640 while wearing or not wearing the glasses 600. For example, the display unit may be formed on an outer side of the left shutter 610L or the right shutter 610R, or a lens rim of the glasses frames 620. In addition, the glasses 600 may further include a sensing unit 650 that is configured to sense biological information of the user. Meanwhile, a driving circuit unit of the glasses 600 includes a shutter driving unit 660, a control unit 670, and a wireless reception unit 680.

As an example, the sensing unit 650 may include a fatigue information sensing unit 651 and/or a dominant eye information sensing unit 655. The sensing unit 650 may be a photodetector for sensing the biological information. For example, as illustrated in FIG. 15, the sensing unit 650 may include left and right sensors 650L and 650R. The left and right sensors may be respectively formed at outer sides of the left and right shutters 610L and 610R. As an example, the left and right sensors 650L and 650R may respectively sense blinks of left and right eyes of the user. Because blinking frequencies of the left and right eyes are closely correlated with the fatigue of the user, the biological information regarding fatigue. A dominant eye of the user may be sensed based on the blinking frequencies of the left and right eyes of the user.

The control unit 670 includes a 3D/2D mode change unit 671 for changing between 2D and 3D modes, a fatigue level determination unit 673 that is configured to determine a fatigue level of the user, and an eye dominance determination unit 675 that is configured to determine eye dominance of the user. For example, biological information sensed by the sensing unit 650 is input to the fatigue level determination unit 673 of the control unit 670, and the fatigue level determination unit 673 calculates the fatigue level of the user based on the input biological information. The fatigue level determination unit 673 further determines whether the calculated fatigue level is greater than a reference value. If the calculated fatigue level is greater than the reference value, the display unit 640 may display a message asking whether the user wants to change modes. As an example, the fatigue level calculated by the fatigue level determination unit 673 may be displayed on the display unit 640 or on an additional fatigue level display unit (not shown). If the glasses 600 are changed from a 3D mode into a 2D mode, the fatigue level calculated by the fatigue level determination unit 673 may also be used by the eye dominance determination unit 675 to determine the eye dominance of the user. The display unit 640 may display that the glasses 600 are being changed into the 2D mode and that the glasses 600 are in an eye dominance determination mode.

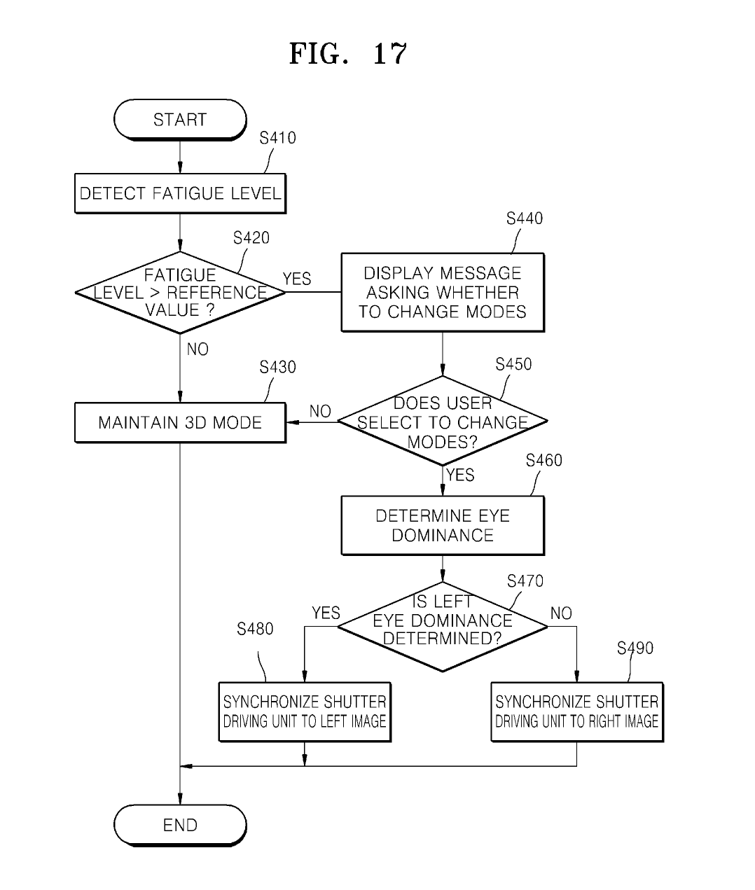

The other features illustrated in FIGS. 15 and 16 substantially correspond to those of the glasses 100 illustrated in FIGS. 1 through 4. Therefore, for the clarity and conciseness, such features are not further described with regard FIGS. 15 and 16. Operation of a 3D image display system will now be described with reference to FIG. 17. 2D and 3D mode operations of the glasses 600 and a 3D image display operation of the 3D image display device 200 are the substantially similar to those described above in relation to FIGS. 1 through 5. In addition to the 2D and 3D mode operations and the 3D image display operation, the 3D image display system changes modes by sensing fatigue and a dominant eye of a user as described below.

FIG. 17 is a flowchart that illustrates an example of a method of changing between 2D and 3D modes in the 3D image display system illustrated in FIG. 16.

Referring to FIG. 17, it is assumed that a user views a 3D image displayed on the 3D image display device 200 in a 3D mode of the glasses 600. The glasses 600 sense biological information of the user in a predetermined cycle by using the sensing unit 650, and calculate a fatigue level of the user based on the sensed biological information (operation S410). As an example, operation S110 may be performed by manual manipulation by the user.

The fatigue level determination unit 673 determines whether the calculated fatigue level is greater than a reference value (operation S420). If the fatigue level is equal to or less than the reference value, the 3D mode of the glasses 600 is maintained (operation S430). Otherwise, if the fatigue level is greater than the reference value, a message asking whether to change the 3D mode into a 2D mode is communicated to the user. For example, a message asking whether to change the 3D mode into a 2D mode may be displayed on the display unit 640 (operation S440). The user may then select whether to change modes (operation S450). If the user does not react (e.g., select whether to change modes) for a predetermined period of time or selects by using the change switch 630 not to change modes, the 3D mode of the glasses 600 is maintained (operation S430). Otherwise, if the user selects by using the change switch 630 to change the 3D mode into the 2D mode, the glasses are switched into a 2D mode. For example, the 3D/2D mode change unit 671 of the glasses 600 changes the 3D mode into the 2D mode.

If the user selects to change the glasses 600 from the 3D mode into the 2D mode, an eye dominance determination mode may be started (operation S460). The eye determination mode may be started automatically based on the user selecting to change the glasses 600 into the 2D mode. When the eye dominance determination mode is started (operation S460), the display unit 640 may display that the glasses 600 are in the eye dominance determination mode. As an example, the eye dominance determination mode may be performed the same as operations S320 through S360 illustrated in FIG. 14. Eye dominance of the user is determined in the eye dominance determination mode (operation S470). If left eye dominance is determined in the eye dominance determination mode in operation S470, the control unit 670 synchronizes the shutter driving unit 660 to a left image (operations S480). In other words, the control unit 670, when in a left eye dominance mode, drives the left and right shutters 610L and 610R of the glasses 600 to be open when the left image L (see FIG. 4) is displayed, and to be closed when the right image R (see FIG. 4) is displayed. As an example, the left and right shutters 610L and 610R of the glasses 600 may be driven so as to be open only when the left image L is displayed. If right eye dominance is determined in the eye dominance determination mode in operation S470, the control unit 670 synchronizes the shutter driving unit 660 to a right image (operation S490). In other words, the control unit 670, when in a right eye dominance mode, drives the left and right shutters 610L and 610R of the glasses 600 to be open when the right image R is displayed, and to be closed when the left image L is displayed. As an example, the left and right shutters 610L and 610R of the glasses may be driven so as to be open only when the right image R is displayed.

As described above, if a fatigue level and eye dominance of a user is determined, the user may view an image more stably in a 2D mode of the glasses 600.

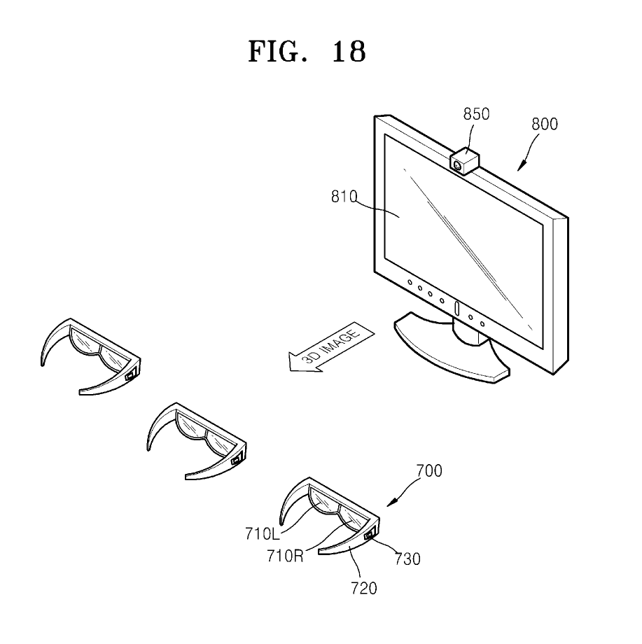

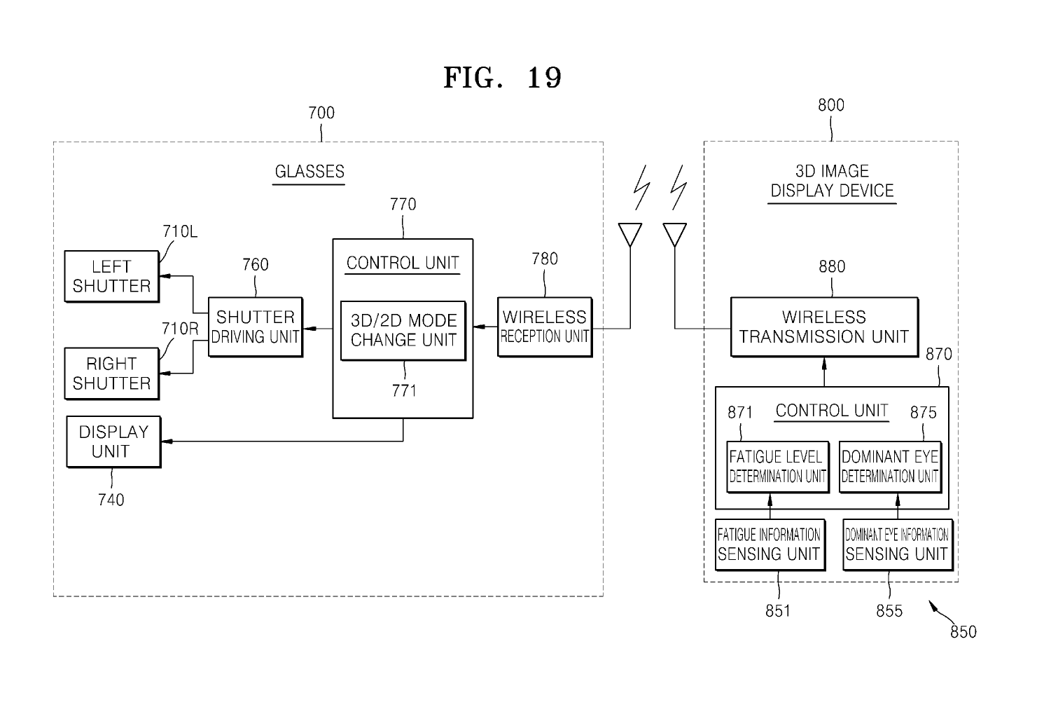

FIG. 18 illustrates an example of a 3D image display system. FIG. 19 is a block diagram of a 3D image display system, such as, for example, the image display system illustrated in FIG. 18.

Referring to FIGS. 18 and 19, the 3D image display system includes glasses 700 and a 3D image display device 800.

The glasses 700 allow viewing of an image displayed on the 3D image display device 800, and include left and right shutters 710L and 710R. The left and right shutters 710L and 710R may respectively correspond to left and right lenses of glasses frames 720. A change switch 730 is provided to enable a user to change between the 2D and 3D modes. As an example, the change switch 730 may be formed at one side of the glasses frames 720. Meanwhile, a driving circuit unit of the glasses 700 includes a shutter driving unit 760, a control unit 770, and a wireless reception unit 780. The other features of the glasses 700 substantially correspond as those of the glasses 100 illustrated in FIGS. 1 through 4, and thus will not be described here.

The 3D image display device 800 includes an image panel 810, a sensing unit 850, a control unit 870, and a wireless transmission unit 880. The image panel 810 and the wireless transmission unit 880 are the same as the image panel 210 and the wireless transmission unit 280 of the 3D image display device 200 illustrated in FIGS. 1 through 4.

The sensing unit 850 may include a fatigue information sensing unit 851 and a dominant eye information sensing unit 855. As an example, the sensing unit 850 may be a photodetector for sensing biological information of a user. For example, as illustrated in FIG. 18, the sensing unit 850 may be formed at one side of the 3D image display device 800, and may sense blinks of left and right eyes of the user. As described above in relation to FIGS. 1 through 17, blinking frequencies of the left and right eyes are closely correlated with fatigue of the user. The biological information regarding fatigue and a dominant eye of the user may be sensed by using the blinking frequencies of the left and right eyes of the user. Moreover, as an example, the sensing unit 850 may be formed on at least one side of the 3D image display device 800 and may sense blinks of left and right eyes of a plurality of users.

The control unit 870 controls the 3D image display device 800, and the image panel 810 transmits to the wireless transmission unit 880 a synchronization signal used to display left and right images. In addition, the control unit 870 may include a fatigue level determination unit 871 that is configured to determine a fatigue level of the user based on the biological information transmitted from the fatigue information sensing unit 851. The control unit 870 may also include an eye dominance determination unit 875 that is configured to determine eye dominance of the user based on the biological information transmitted from the dominant eye information sensing unit 855.

The wireless transmission unit 880 may transmit information regarding the user's fatigue level and eye dominance together with the synchronization signal received from the control unit 870. As another example, the wireless transmission unit 880 may also transmit information regarding the user's fatigue level and eye dominance separate from the synchronization signal.

In such a 3D image display system, because the sensing unit 850, the fatigue level determination unit 871, and the eye dominance determination unit 875 are included in the 3D image display device 800, the glasses 700 may have simple mechanical and control structures, and thus may have a compact size.

In some aspects, the sensing unit 850 may be included in the 3D image display device 800, and the fatigue level determination unit 871 and/or the eye dominance determination unit 875 may be included in the control unit 770 of the glasses 700. In such aspects, the biological information sensed by the sensing unit 850 of the 3D image display device 800 may be transmitted via the wireless transmission unit 880 to the wireless reception unit 780 of the glasses 700. Accordingly, the glasses 700 may determine the fatigue level or the eye dominance of the user based on the biological information received by the wireless reception unit 780.

Although FIGS. 1 through 19 illustrate an example of a 3D image display system in which the synchronization signal is wirelessly transmitted, some aspects may communicate synchronization signals by other means. In other words, aspects are not limited to the examples describing wirelessly transmitting the synchronization signal. For example, the synchronization signal may be transmitted and received by a wire connected between the 3D image display system 200 or 800 and the glasses 100, 101, 300, 400, 500, 600, or 700.

In some aspects, there is provided glasses capable of reducing a user's dizziness caused by, for example, fatigue while viewing a three-dimensional (3D) image, a 3D image display system employing the same, and a method of allowing viewing of an image.

As described above, a user's dizziness caused by, for example, fatigue, while viewing a three-dimensional (3D) image may be easily solved. For example, if a plurality of users view a 3D image displayed on a 3D image display device and only some of the users feel fatigue due to the 3D image, the users who feel fatigue may view the 3D image displayed on the 3D image display device, as a 2D image by using a 2D glasses mode without interrupting the other viewers who view the 3D image.

The units described herein may be implemented using hardware components and software components. For example, microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. Eyewear through which left and right images alternately displayed on a three-dimensional (3D) image display device are viewed, the eyewear comprising:
left and right shutters;
a shutter driving unit that is configured to drive the left and right shutters; and
a control unit that is configured to control the shutter driving unit in a two-dimensional (2D) mode in which only one of the left and right images displayed on the 3D image display device is viewable.

2. The eyewear of claim 1, wherein the control unit comprises a 3D/2D mode change unit that is configured to change the eyewear between 2D and 3D modes.

3. The eyewear of claim 2, wherein, if the 3D/2D mode change unit changes the 3D mode into the 2D mode, the control unit controls the shutter driving unit so as to simultaneously open and close the left and right shutters in synchronization with only one of the left and right images displayed on the 3D image display device, and
wherein, if the 3D/2D mode change unit changes the 2D mode into the 3D mode, the control unit controls the shutter driving unit so as to open and close the left shutter in synchronization with the left image being displayed on the 3D image display device, and to open and close the right shutter in synchronization with the right image being displayed on the 3D image display device.

4. The eyewear of claim 2, further comprising a fatigue level detection unit that is configured to detect a fatigue level of a user who views a 3D image through the eyewear as the eyewear is in the 3D mode.

5. The eyewear of claim 4, wherein the fatigue level detection unit comprises:
a fatigue information sensing unit that is configured to sense user information; and
a fatigue level determination unit that is configured to calculate a fatigue level of the user based on the user information, and to compare the calculated fatigue level to a reference value.

6. The eyewear of claim 5, further comprising a fatigue level display unit that is configured to display information associated with the fatigue level of the user.

7. The eyewear of claim 5, further comprising a mode change display unit that is configured to display a message prompts the user to decide whether to change the 3D mode into the 2D mode, if the fatigue level determination unit determines that the fatigue level is greater than the reference value.

8. The eyewear of claim 5, wherein the 3D/2D mode change unit manually or automatically changes the 3D mode into the 2D mode if the fatigue level determination unit determines that the fatigue level is greater than the reference value.

9. The eyewear of claim 1, further comprising an eye dominance selection unit that is configured to select a left eye dominance mode or a right eye dominance mode.

10. The eyewear of claim 9, wherein, in the 2D mode, the control unit controls the shutter driving unit to simultaneously open and close the left and right shutters in synchronization with only the left image displayed on the 3D image display device in the left eye dominance mode, and to simultaneously open and close the left and right shutters in synchronization with only the right image displayed on the 3D image display device in the right eye dominance mode.

11. The eyewear of claim 9, further comprising:
a dominant eye information sensing unit that is configured to sense user information; and
an eye dominance determination unit for determining eye dominance of the user based on the user information.

12. The eyewear of claim 11, wherein the eye dominance determination unit operates:
in a left-eye test mode for opening the left shutter and closing the right shutter in synchronization with only one of the left and right images displayed on the 3D image display device so as to determine whether the user has left eye dominance; and
in a right-eye test mode for closing the left shutter and opening the right shutter in synchronization with only one of the right and right images displayed on the 3D image display device so as to determine whether the user has right eye dominance.

13. The eyewear of claim 11, wherein the left eye dominance mode or the right eye dominance mode is manually or automatically selected according to the user's eye dominance determined by the eye dominance determination unit.

14. The eyewear of claim 11, further comprising:
a fatigue information sensing unit that is configured to sense user information;
a fatigue level calculation unit that is configured to calculate a fatigue level of the user based on the user information; and
a fatigue level determination unit that is configured to compare the fatigue level calculated by the fatigue level calculation unit, to a reference value,
wherein the fatigue information sensing unit is also used as the dominant eye information sensing unit.

15. A three-dimensional (3D) image display system comprising:
a 3D image display device for alternately displaying left and right images; and
eyewear through which the left and right images displayed on the 3D image display device are viewed,
wherein the eyewear comprise:
left and right shutters;
a shutter driving unit that is configured to drive the left and right shutters; and
a control unit that is configured to control the shutter driving unit in a two-dimensional (2D) mode in which only one of the left and right images displayed on the 3D image display device is viewable.

16. The 3D image display system of claim 15, wherein the eyewear further comprises at least one of:
a fatigue level detection unit that is configured to detect a fatigue level of a user who views a 3D image through the eyewear as the eyewear is in a 3D mode; and
an eye dominance selection unit that is configured to select a left eye dominance mode or a right eye dominance mode.

17. The 3D image display system of claim 15, wherein the 3D image display device comprises at least one of:
a fatigue level detection unit that is configured to detect a fatigue level of a user who views a 3D image through the eyewear as the eyewear is in a 3D mode; and
an eye dominance selection unit that is configured to select a left eye dominance mode or a right eye dominance mode.

18. A method of allowing viewing of left and right images alternately displayed on a three-dimensional (3D) image display device, the method comprising:
preparing eyewear comprising left and right shutters; and
controlling the left and right shutters in a two-dimensional (2D) mode in which only one of the left and right images displayed on the 3D image display device is viewable.

19. The method of claim 18, wherein the controlling of the left and right shutters comprises controlling the left and right shutters so as to be simultaneously open and closed in synchronization with only one of the left and right images displayed on the 3D image display device.

20. The method of claim 18, further comprising:
sensing user information of a user who wears the glasses;
calculating a fatigue level of the user based on the sensed user information; and
changing a 3D mode into the 2D mode if the calculated fatigue level is greater than a reference value.
